(19) United States
(12) Patent Application Publication
(10) Pub. No.: US 2022/0206929 A1
(43) Pub. Date: Jun. 30, 2022

(54) MANAGING A GLOBAL NETWORK OF VIRTUAL TESTERS

(71) Applicant: Sauce Labs Inc., San Francisco, CA (US)

(72) Inventors: Rajagopal Rao, San Jose, CA (US); Ram Shanmugam, Fremont, CA (US); Krishna Srinivasan, San Francisco, CA (US)

(21) Appl. No.: 17/644,498

(22) Filed: Dec. 15, 2021

Related U.S. Application Data
(60) Provisional application No. 63/133,144, filed on Dec. 31, 2020.

(51) Int. Cl. G06F 11/36

(52) U.S. Cl. CPC G06F 11/3664; G06F 11/3684; G06F 11/3688

(57) ABSTRACT

Methods and apparatus are described for testing the operation of a software application in a manner that reproduces the conditions under which the application operates. Semi-autonomous virtual testing software agents are deployed to the remote cloud computing infrastructure of each geographic region of interest. Each software agent has its own “personality” that includes its geolocation, along with the device types, operating systems, and (in the case of web applications) browser types with which the application is expected to operate in each geographic region.

### INCORPORATION BY REFERENCE

An Application Data Sheet is filed concurrently with this specification as part of this application. Each application to which this application claims benefit or priority as identified in the concurrently filed Application Data Sheet is incorporated by reference herein in its entirety and for all purposes.

### BACKGROUND

Software development, testing, and production often takes for granted that the network infrastructure conditions under which a software application is developed, tested, and produced are representative of the conditions under which the application will operate for an end user regardless of the geographic location of that user. For a variety of reasons, this assumption may not be warranted, potentially resulting in inconsistent user experiences and, at worst, inoperable software. On the other hand, manually implementing testing in every geographic location in which an application is intended to operate will often not be feasible.

Moreover, conventional indicators of the operational status of network infrastructure components (e.g., component heartbeats) are often insufficient to represent or support detection of problems with the operation of a given application. For example, even though a router or server might indicate that it is operating correctly, such indications are typically associated with layers 1 through 3 of the network stack rather than the application layer in which the problem is likely occurring.

For a global enterprise that relies on software tools to facilitate communication among employees and customers around the world, such issues can be catastrophic.

### SUMMARY

According to various implementations, methods, systems, and computer-readable media are provided in which an application is selected for testing in one or more geographic regions. A plurality of configuration parameters is specified for each of one or more software agents. The configuration parameters for each of the one or more software agents represent a corresponding one of the geographic regions, one or more device types, and one or more operating systems for each of the one or more device types. Instantiation of each of the one or more software agents is triggered in a remote cloud computing infrastructure associated with the corresponding geographic region. Test instructions are provided to each of the one or more software agents. The test instructions correspond to test script configured to test the application in the remote cloud computing infrastructure in the corresponding geographic region using virtual computing resources emulating the one or more devices types and the one or more operating systems for each of the one or more device types. Test results are received from each of the one or more software agents. The test results received from each software agent represent interaction of the software agent and the application based on the test script in the remote cloud computing infrastructure associated with the corresponding geographic region.

According to a particular implementation, the test instructions are natural language test instructions, and each software agent is configured to generate the test script from the natural language test instructions at run time. According to a more specific implementation, the natural language test instructions are derived from a Requirements Traceability Matrix corresponding to the application.

According to another implementation, the application is a web application, and the configuration parameters for each of the one or more software agents includes one or more browser types for each combination of the one or more device types and the one or more operating systems. According to a more specific implementation, at least some of the test script is configured to control browser interactions with the application.

According to another implementation, the application is a mobile application, and at least some of the test script is configured to control mobile operating system interactions with the application.

According to another implementation, each of the one or more software agents is configured to trigger instantiation of the virtual computing resources in the remote cloud computing infrastructure in the corresponding geographic region.

According to another implementation, specifying the configuration parameters for each of the one or more software agents includes selecting a previously stored configuration parameter set.

A further understanding of the nature and advantages of various implementations may be realized by reference to the remaining portions of the specification and the drawings.

### BRIEF DESCRIPTION OF THE DRAWINGS

FIG. 1 is a diagram illustrating an example of the operation of a particular implementation.

FIG. 2 is a simplified diagram of a computing environment in which implementations enabled by the present disclosure may be practiced.

FIG. 3 is a flowchart illustrating operation of a particular implementation.

FIG. 4 is a simplified diagram of an example of an implementation of a virtual testing software agent enabled by the present disclosure.

### DETAILED DESCRIPTION

Reference will now be made in detail to specific implementations. Examples of these implementations are illustrated in the accompanying drawings. It should be noted that these examples are described for illustrative purposes and are not intended to limit the scope of this disclosure. Rather, alternatives, modifications, and equivalents of the described implementations are included within the scope of this disclosure as defined by the appended claims. In addition, specific details may be provided in order to promote a thorough understanding of the described implementations. Some implementations within the scope of this disclosure may be practiced without some or all of these details. Further, well known features may not have been described in detail for the sake of clarity.

The present disclosure describes techniques for testing the operation of a software application (an application under test or AUT) in a manner that reproduces the conditions under which instances of the AUT actually operates. Semi-autonomous virtual testing software agents are deployed to the remote cloud computing infrastructure of each geographic region of interest (also referred to herein as a geolocation). Each software agent has its own “personality” that includes its geolocation and the AUT, along with the device types, operating systems, and (in the case of web applications) browser types with which the AUT is expected to operate in each geographic region.

The software agent secures and/or configures the necessary virtual computing resources on demand in its geolocation to emulate any desired device/OS combinations and applies test script to each instance of the AUT operating with each combination. Because each virtual testing software agent tests the AUT under conditions that are similar to those experienced by end users in the corresponding geographic regions, the operability of the AUT in those regions can be more reliably determined. An example will be instructive.

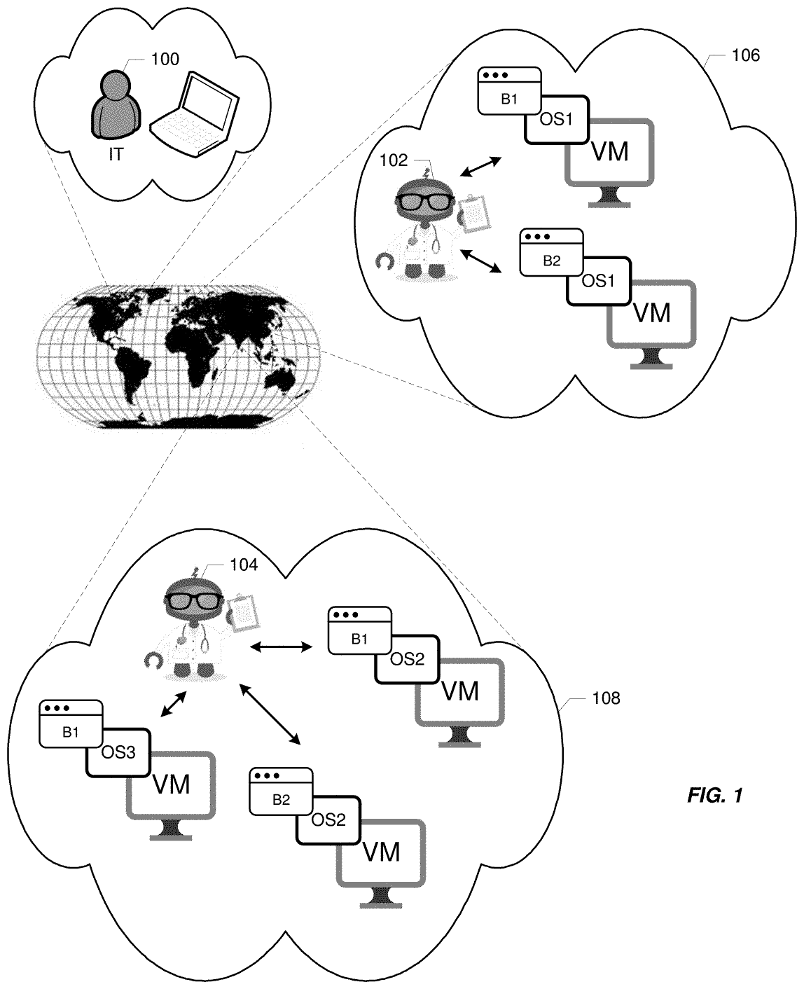

FIG. 1 illustrates an example in which an IT administrator 100 of an enterprise located in New York tests the functionality of a web-based customer relationship management (CRM) software application for users located in Stockholm and Bangalore. In the depicted example, the IT administrator needs only to select the geographic locations and identify the CRM application to cause software agents 102 and 104 to be activated or instantiated in geolocations 106 and 108, respectively.

The additional details of the personalities of software agents 102 and 104 may already be configured based on the known users and user devices for that enterprise in those geographic regions. These are represented by the virtual computing resources in each geolocation representing the various device/OS/browser combinations.

To initiate testing, the IT administrator communicates the desired functionality to be tested to the software agents. This might be done by selecting from a list of functionalities or by entering natural language descriptions of the functionalities. For example, the functionalities might include “log in to the CRM application” and “create a lead.” Each software agent receives this information and generates the necessary test scripts locally to determine whether the CRM application can successfully perform these functions in those geographic regions.

Because the test scripts are generated and applied locally, the IT administrator can more reliably determine whether the enterprise's users in each geographic location can successfully use the CRM application.

As will be appreciated by those of skill in the art, some implementations enabled by the present disclosure enable so-called “citizen testers” to successfully test application functionality around the world. A citizen tester is a person who initiates the testing function without any specialized software testing expertise or training. Citizen testers are often domain experts in some business sector, e.g., sales ops, finance ops, talent management, HR, etc., that relies on specific cloud-based software. These domain experts typically have no expertise in testing or test automation, yet are often expected to oversee and even perform the testing on which their users rely.

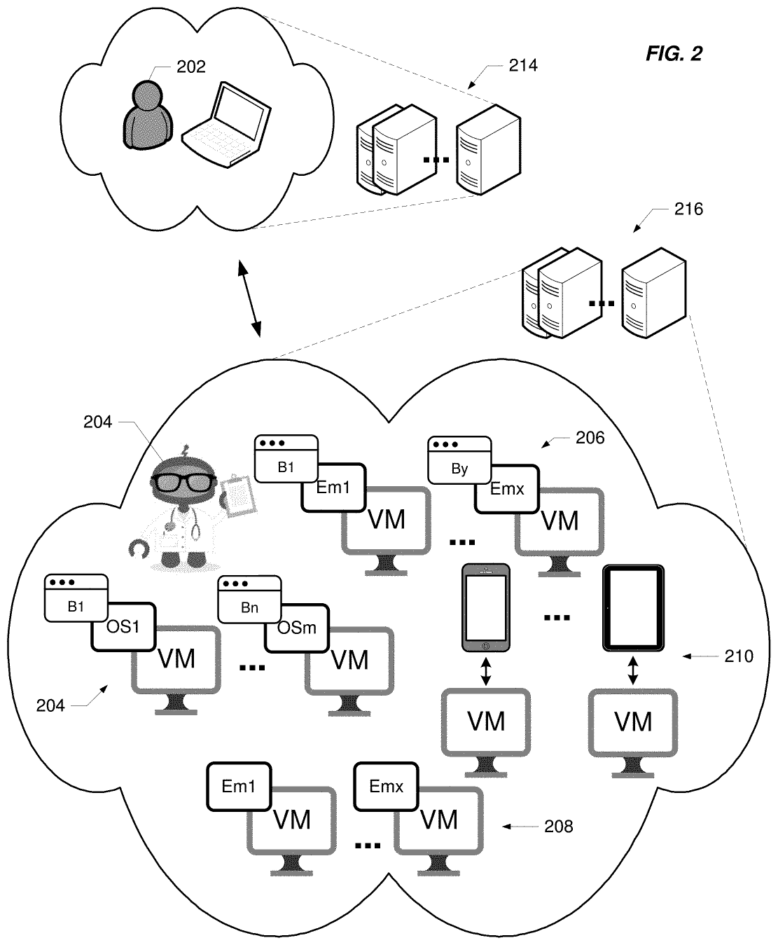

FIG. 2 depicts an example of a computing environment in which application developers, QA engineers, IT professionals, citizen testers, etc. (represented by user 202), conduct testing of an AUT in accordance with the techniques described herein. As will be discussed, instances of the AUT are tested using virtual and/or hardware computing resources in cloud-based network infrastructure in any of a number of geographic regions (e.g., geolocations).

As depicted in FIG. 2, the virtual and hardware resources with which an AUT may be tested may be of a wide variety of types. For example, an AUT which is a web-based application may be tested on potentially hundreds of browser and operating system (OS) combinations 204 as represented by various combinations of browsers B 1-Bn and operating systems OS1-OSm on corresponding virtual machine (VM) instances. These VM instances may represent, for example, Windows, Mac, and Linux-based machines to name some representative examples.

In another example, an AUT that is a mobile web application may be tested on potentially hundreds of mobile browser and mobile device emulator combinations as represented by various combinations 206 of mobile browsers B 1-By and emulators Em1-Emx on corresponding VM instances. An AUT that is a native mobile application may be tested on potentially hundreds of mobile device emulators as represented by combinations 208 of emulators Em1-Emx and corresponding VM instances. The depicted emulators may represent, for example, iOS Simulators and Android Emulators to name some representative examples. And while the emulators are shown as operating on corresponding VMs, the software agents enabled by the present disclosure will typically primarily interact with or automate on the emulators.

According to some implementations, both mobile web applications and native mobile applications may be tested on potentially hundreds of hardware mobile device types (e.g., smart phones, tablets, etc.) as represented by combinations 210 of various device types and corresponding VM instances that manage the interaction with a corresponding mobile device during testing. The depicted devices may represent, for example, physical phones or tablets for Android and iOS to name some representative examples.

It should be noted that the virtual and hardware resources depicted in FIG. 2 and other examples described herein show the use of VMs for exemplary purposes. It will be understood that other mechanisms for providing isolation among applications operating in a shared computing environment are contemplated to be within the scope of the present disclosure. Such other mechanisms include, for example, containers such as those provided by Docker, Inc., or CoreOS, Inc., both of San Francisco, Calif. The present disclosure will refer generally to VMs, containers, and other suitable mechanisms for providing isolation among applications in computing environments as “virtual computing resources.” The present disclosure should therefore not be limited by reference to specific examples using VMs.

The virtual testing software agents enabled by the present disclosure support a wide range of application testing use cases. A single developer, IT professional, or citizen tester (e.g., user 202) might use a software agent to run a single test of an AUT with one combination of testing resources. At the other end of the scale, a team of developers, IT professionals, or citizen testers associated with a large enterprise can implement an automated testing framework at scale, using multiple software agents to run multiple tests of multiple AUTs on many different combinations of testing resources.

A virtual testing software agent enabled by the present disclosure (e.g., software agent 212) might use any of a variety of automation drivers to interact with web or mobile applications including, for example, Selenium and WebDriver for web applications, and Appium, Espresso, XCUltest (Xcode), and Robotium for mobile applications. For example, software agent 212 might spin up a Selenium driver using local virtual computing resources to interact with a web application. Software agent 212 might also interact directly with a browser or AUT without an intervening driver. Whatever the interaction mechanism, driver type, or testing framework, software agent 212 issues a command for interacting with the AUT and then, once that command is executed, software agent 212 queries the state of the AUT induced by the execution of the command. This state may include not only conventional test results, but any information relating to the induced state of the AUT.

As will be appreciated, the depiction of the virtual and hardware computing resources in FIG. 2 is for illustrative purposes. More generally, the computing resources and corresponding platforms employed as described herein may conform to any of a wide variety of architectures deployed at one or more geolocations, each implemented with one or more servers (as represented by servers 214 and 216). The network infrastructure supporting such resources may be any subset or combination of a wide variety of network environments including, for example, TCP/IP-based networks, UDP/IP-based networks, telecommunications networks, wireless networks, satellite networks, cable networks, public networks, private networks, wide area networks, local area networks, the Internet, the World Wide Web, intranets, extranets, and so on. The computing devices with which developers, IT professionals, or citizen testers implement testing of an AUT may be any suitable device capable of connecting to such network infrastructure and interacting with virtual testing software agents.

Implementations enabled by the present disclosure are based on computing models that enable ubiquitous, convenient, on-demand network access to both virtual and hardware resources from one or more shared pools of computing resources (e.g., mobile devices, virtual machines, containers, emulators, networks, servers, storage, applications, services, etc.). Virtual resources are thoroughly torn down or wiped and hardware resources thoroughly wiped once testing is complete to ensure the security of each user's or enterprise's data. As will be understood, such computing resources may be integrated with and/or under the control of the same entity controlling the testing platform. Alternatively, such resources may be associated with other platforms that are at least partially controlled by other entities, e.g., a platform under control of a separate provider of cloud services and/or computing resources with which the developer, IT professional, or citizen tester connects to consume resources as needed. Based on the foregoing, the diversity of variations within the scope of this disclosure will be appreciated by those of skill in the art.

It should also be noted that, despite any references to particular computing paradigms and software tools herein, the computer program instructions on which various implementations are based may correspond to any of a wide variety of programming languages, software tools and data formats, may be stored in any type of non-transitory computer-readable storage media or memory device(s), and may be executed according to a variety of computing models including, for example, a client/server model, a peer-to-peer model, on a stand-alone computing device, or according to a distributed computing model in which various functionalities may be effected or employed at different locations.

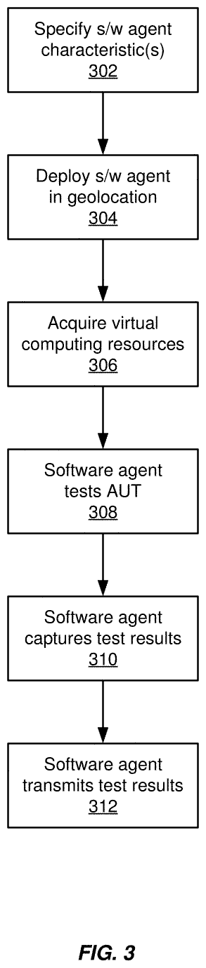

The operation of a virtual testing software agent enabled by the present disclosure will now be described with reference to the flowchart of FIG. 3. In response to a user specifying the “personality” of the software agent (302) (e.g., identifying the AUT and the geolocation), a virtual testing software agent is instantiated or activated in the corresponding geolocation (304). According to some implementations, a virtual testing software agent may be implemented as a set of one or more serverless automation script execution engines that lie dormant in the cloud infrastructure of the corresponding geolocation until needed. According to a particular implementation, each virtual testing software agent incorporates the core functionality of the testing software platform known as AutonomlQ, Inc., from Sauce Labs, Inc., of San Francisco, Calif.

Depending on the implementation, the software agent's personality may include a variety of characteristics that may be specified in a variety of ways. For example, the user might be a developer, IT professional, or a citizen tester of a global enterprise which provides and maintains end user devices (e.g., desktops, laptops, or any of a variety of mobile device types) for each of its users. The device types, current versions of operating systems, current browser types and versions, and supported applications associated with the enterprise might be stored in an IT database. Thus, the user might merely need to specify a particular geographic region to have these additional characteristics automatically specified based on the known users in that region. Alternatively, each of the characteristics might be specified or selected from available options in the menu(s) of the user's interface.

The virtual computing resources necessary for testing the AUT are instantiated in the geolocation associated with each software agent (306). For example, device/emulator/OS/browser combinations representing the user population for the software agent's geolocation are acquired in the cloud infrastructure associated with that geographic region. These resources may be automatically instantiated in parallel with the instantiation of the software agent. Alternatively, these resources may be instantiated under the control of the software agent based on that software agent's understanding of its own personality (e.g., based on the devices of a known user population).

The software agent issues test commands to the AUT and/or its corresponding virtual computing resources (308) using any of a variety of automation software and/or testing frameworks including, for example, various automation drivers, e.g., Selenium and WebDriver for web application testing, and Appium, Espresso, XCUltest (Xcode), and Robotium for mobile application testing.

These test commands may be sent to the selected resources via a secure, two-way connection (e.g., a secure HTTP tunnel). There may also be a secure two-way connection from the selected testing resources to the AUT in cases where the AUT is operating separately from the virtual computing resources. For example, if the AUT is a web application, secure HTTP tunnels between the software agent and a VM, and the AUT and the VM may be established. In the context of web application testing, Selenium commands issued by the software agent are applied to each browser via one tunnel, and the browser then interacts with the AUT in a corresponding way via the other tunnel. As will be appreciated, while the use of highly secure connections may be preferable in some circumstances, implementations are contemplated in which different levels of security are used.

According to some implementations, the test scripts from which the test commands are generated are themselves generated locally by the software agent. That is, the test scripts, e.g., Selenium or Appium code, may be generated, compiled, and executed by the software agent in real time so that the test script is tightly integrated with the current conditions at that geolocation for the specific device/OS/browser combinations.

According to some of these implementations, the test script is generated by the software agent from natural language representations of the functionality to be test (e.g., the test intent) entered or selected by the user. For example, natural language test intent may be represented in the Requirements Traceability Matrix (RTM) for the AUT. The software agent may be configured to use the RTM to interpret natural language input to generate the corresponding test scripts. Alternatively, the user may navigate a menu of natural language test intent, selection of which results in providing information to the software agent for generation of the necessary scripts.

The results of the application of the test commands are captured by the software agent (310) and transmitted back to the user (312). The captured information may include, for example, the command and responses (e.g., from Selenium or Appium logs), as well as video or screen shots of the browser UI and/or AUT after each page-altering command. In the context of web applications, the captured information might also include the HTML of a web page. In the context of native applications for mobile devices, the captured information might include state data and elements with which the software agent can interact as inferred from an XML document extracted from the automated execution environment, e.g., details about the geometry and contents of elements on the screen.

As will be appreciated from the foregoing, a single user at one location can orchestrate deployment of virtual testing software agents on demand at geolocations of interest anywhere in the world, with each of those software agents testing an AUT using virtual computing resources in each of those geolocations. The AUT and the associated functionality tested in each geolocation may be the same, or may be varied for each geolocation. Thus, with implementations enabled by the present disclosure, a global enterprise can reliably determine whether the software applications its employees need to do their jobs operate as intended in each of the geographic regions in which the enterprise has a presence.

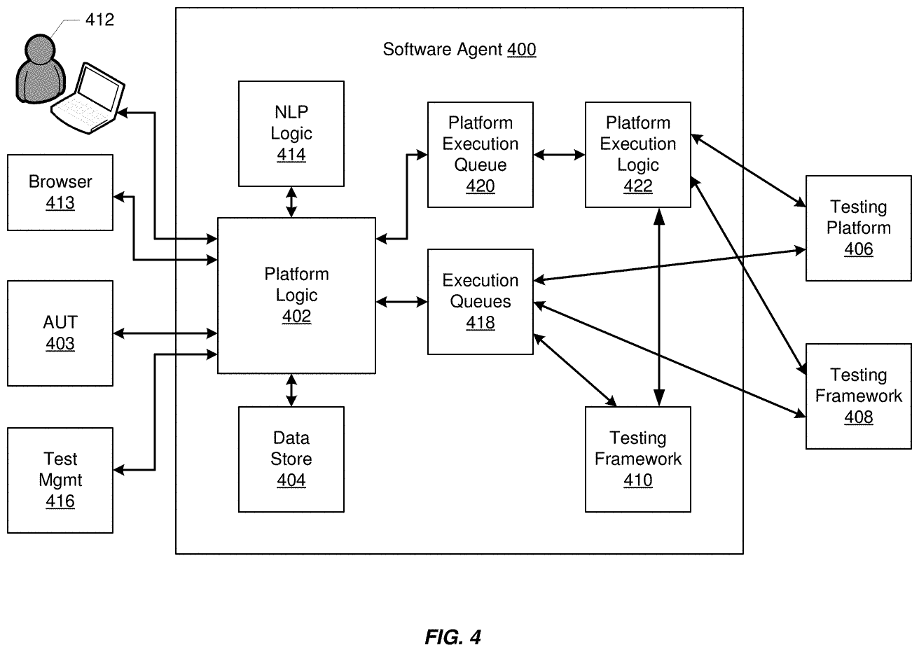

FIG. 4 provides a simplified diagram of an example of a virtual testing software agent enabled by the present disclosure. Software agent 400, which is deployed in a particular geolocation, includes core platform logic 402 that orchestrates communication among the external and internal system components including AUT 403 and data store 404 which may store any of the data required for testing AUT 403 in the geolocation in which the software agent is deployed. Such data may include, for example, agent characteristics, user data, test scripts, information about AUT 403, test results, etc.

Software agent 400 may interact with virtual and/or hardware resources of an external testing platform 406 such as, for example, the Sauce Labs continuous testing platform. Software agent 400 may employ external testing frameworks 408 or integrated frameworks 410 (e.g., Selenium, Appium, etc.). Users 412 may interact directly with software agent 400 or using any of a variety of browsers 413 to access natural language processing logic 414 which may translate natural language input on the fly to generate test scripts or employ predetermined phrases that map to test scripts that represent the testing of particular functionality.

Users may also employ test management platforms and services 416 such as, for example, Jenkins, Zephyr, HP ALM, Semaphore, AQI Recorder, etc., to introduce test scripts and capture test results. Multiple parallel execution queues 418 feed into platform execution queue 420 and platform execution logic 422, enabling multiple concurrent users. Software agent 400 may be implemented using any of a variety of programming languages including, for example, Python, C++, Java, Objective-C, or Ruby, to name some representative examples.

It will be understood by those skilled in the art that changes in the form and details of the implementations described herein may be made without departing from the scope of this disclosure. In addition, although various advantages, aspects, and objects have been described with reference to various implementations, the scope of this disclosure should not be limited by reference to such advantages, aspects, and objects. Rather, the scope of this disclosure should be determined with reference to the appended claims.

What is claimed is:

1. A computer-implemented method, comprising:
selecting an application for testing in one or more geographic regions;
specifying a plurality of configuration parameters for each of one or more software agents, wherein the configuration parameters for each of the one or more software agents represent a corresponding one of the geographic regions, one or more device types, and one or more operating systems for each of the one or more device types;
triggering instantiation of each of the one or more software agents in a remote cloud computing infrastructure associated with the corresponding geographic region;
providing test instructions to each of the one or more software agents, the test instructions corresponding to test script configured to test the application in the remote cloud computing infrastructure in the corresponding geographic region using virtual computing resources emulating the one or more devices types and the one or more operating systems for each of the one or more device types; and
receiving test results from each of the one or more software agents, the test results received from each software agent representing interaction of the software agent and the application based on the test script in the remote cloud computing infrastructure associated with the corresponding geographic region.

2. The method of claim 1, wherein the test instructions are natural language test instructions, and wherein each software agent is configured to generate the test script from the natural language test instructions at run time.

3. The method of claim 2, wherein the natural language test instructions are derived from a Requirements Traceability Matrix corresponding to the application.

4. The method of claim 1, wherein the application is a web application, and wherein the configuration parameters for each of the one or more software agents includes one or more browser types for each combination of the one or more device types and the one or more operating systems.

5. The method of claim 4, wherein at least some of the test script is configured to control browser interactions with the application.

6. The method of claim 1, wherein the application is a mobile application, and wherein at least some of the test script is configured to control mobile operating system interactions with the application.

7. The method of claim 1, wherein each of the one or more software agents is configured to trigger instantiation of the virtual computing resources in the remote cloud computing infrastructure in the corresponding geographic region.

8. The method of claim 1, wherein specifying the configuration parameters for each of the one or more software agents includes selecting a previously stored configuration parameter set.

9. A system, comprising one or more computing devices including memory and one or more processors, the one or more computing devices being configured to:
select an application for testing in one or more geographic regions;
specify a plurality of configuration parameters for each of one or more software agents, wherein the configuration parameters for each of the one or more software agents represent a corresponding one of the geographic regions, one or more device types, and one or more operating systems for each of the one or more device types;
trigger instantiation of each of the one or more software agents in a remote cloud computing infrastructure associated with the corresponding geographic region;
provide test instructions to each of the one or more software agents, the test instructions corresponding to test script configured to test the application in the remote cloud computing infrastructure in the corresponding geographic region using virtual computing resources emulating the one or more devices types and the one or more operating systems for each of the one or more device types; and
receive test results from each of the one or more software agents, the test results received from each software agent representing interaction of the software agent and the application based on the test script in the remote cloud computing infrastructure associated with the corresponding geographic region.

10. The system of claim 9, wherein the test instructions are natural language test instructions, and wherein each software agent is configured to generate the test script from the natural language test instructions at run time.

11. The system of claim 10, wherein the natural language test instructions are derived from a Requirements Traceability Matrix corresponding to the application.

12. The system of claim 9, wherein the application is a web application, and wherein the configuration parameters for each of the one or more software agents includes one or more browser types for each combination of the one or more device types and the one or more operating systems.

13. The system of claim 12, wherein at least some of the test script is configured to control browser interactions with the application.

14. The system of claim 9, wherein the application is a mobile application, and wherein at least some of the test script is configured to control mobile operating system interactions with the application.

15. The system of claim 9, wherein each of the one or more software agents is configured to trigger instantiation of the virtual computing resources in the remote cloud computing infrastructure in the corresponding geographic region.

16. The system of claim 9, wherein the one or more computing devices are configured to specify the configuration parameters for each of the one or more software agents by selecting a previously stored configuration parameter set.

17. A computer program product, comprising one or more non-transitory computer-readable media having computer program instructions stored therein, the computer program instructions being configured such that, when executed by one or more computing devices, the one or more computing devices:
select an application for testing in one or more geographic regions;
specify a plurality of configuration parameters for each of one or more software agents, wherein the configuration parameters for each of the one or more software agents represent a corresponding one of the geographic regions, one or more device types, and one or more operating systems for each of the one or more device types;
trigger instantiation of each of the one or more software agents in a remote cloud computing infrastructure associated with the corresponding geographic region;
provide test instructions to each of the one or more software agents, the test instructions corresponding to test script configured to test the application in the remote cloud computing infrastructure in the corresponding geographic region using virtual computing resources emulating the one or more devices types and the one or more operating systems for each of the one or more device types; and
receive test results from each of the one or more software agents, the test results received from each software agent representing interaction of the software agent and the application based on the test script in the remote cloud computing infrastructure associated with the corresponding geographic region.

18. The computer program product of claim 17, wherein the application is a web application, and wherein the configuration parameters for each of the one or more software agents includes one or more browser types for each combination of the one or more device types and the one or more operating systems.

19. The computer program product of claim 17, wherein the application is a mobile application, and wherein at least some of the test script is configured to control mobile operating system interactions with the application.

20. The computer program product of claim 17, wherein each of the one or more software agents is configured to trigger instantiation of the virtual computing resources in the remote cloud computing infrastructure in the corresponding geographic region.
